(19) United States
(12) Patent Application Publication
(10) Pub. No.: US 2011/0107328 A1
(43) Pub. Date: May 5, 2011

(54) VIRTUAL MACHINE DEVICE AND METHODS THEREOF

(75) Inventors: Benjamin C. Serebrin, Sunnyvale, CA (US); David S. Christie, Austin, TX (US); Erich Boleyn, Portland, OR (US); Michael P. Hohmuth, Dresden (DE)

(73) Assignee: ADVANCED MICRO DEVICES, INC., Sunnyvale, CA (US)

(21) Appl. No.: 12/610,640

(22) Filed: Nov. 2, 2009

(51) Int. Cl. G06F 9/455; G06F 9/46

(52) U.S. Cl. 718/1; 718/100

(57) ABSTRACT

A data processing device is configured such that, during a loop executed by a guest, the device executes a PAUSE instruction. In response to executing a PAUSE instruction, the data processing device determines a relationship between the current PAUSE instruction and a previously executed PAUSE instruction. For example, the data processing device can determine the amount of time that has elapsed between the PAUSE instructions. Based on the relationship between the current and previous pause instructions, the data processing device can reset the counter to a reset value, or adjust (i.e. increment or decrement) the counter by a defined amount.

### BACKGROUND

1. Field of the Disclosure

The present disclosure relates to data processing devices and more particularly to data processing devices that support virtual machines.

2. Description of the Related Art

Virtualization has been used in data processing devices for a variety of different purposes. Generally, virtualization of a data processing device may include providing one or more privileged programs with access to a virtual machine over which the privileged program has full control, but the control of the physical device is retained by a virtual machine manager (VMM). The privileged program, referred to herein as a guest, provides commands and other information targeted to hardware expected by the guest. The VMM intercepts the commands, and assigns hardware of the data processing device to execute each intercepted command. Virtualization may be implemented in software (e.g. the VMM mentioned above) without any specific hardware virtualization support in the physical machine on which the VMM and its virtual machines execute. In other embodiments, the hardware of the data processing device can provide support for virtualization.

Both the VMM and the guests are executed by one or more processors included in the physical data processing device. Accordingly, switching between execution of the VMM and the execution of guests occurs in the processors over time. For example, the VMM can schedule a guest for execution, and in response the hardware executes the guest VM. At various points in time, a switch from executing a guest to executing the VMM also occurs so that the VMM can retain control over the physical machine (e.g., when the guest attempts to access a peripheral device, when a new page of memory is to be allocated to the guest, when it is time for the VMM to schedule another guest, etc.). A switch between a guest and the VMM (in either direction) is referred to for purposes of discussion as a “world switch.” Generally, the world switch involves saving processor state for the guest/VMM being switched away from, and restoring processor state for the guest/VMM being switched to.

During execution of a guest, the guest may enter a spin loop, whereby the guest is waiting for the device to perform a designated task, such as retrieve or save information to memory. Depending on the length of the spin loop, it can be desirable to execute a world switch in response to the spin loop to allow the VMM or another guest to be executed by the processor. However, because of the time required to execute a world switch, performing a switch in response to every spin loop can be inefficient. A counter can be employed to count the duration of a spin loop, resulting in execution of a world switch when the counter reaches a threshold. However, the counter can also cause an undesirable world switch in response to multiple relatively short spin loops.

### BRIEF DESCRIPTION OF THE DRAWINGS

FIG. 1 is a block diagram of a data processing device in accordance with one embodiment of the present disclosure.

FIG. 2 is a block diagram of a particular embodiment of the host hardware of FIG. 1.

FIG. 3 is a diagram illustrating an example operation of the data processing device of FIG. 1 in accordance with one embodiment of the present disclosure.

FIG. 4 is a flow diagram of a method of switching from a guest to a VMM in accordance with one embodiment of the present disclosure.

### DETAILED DESCRIPTION

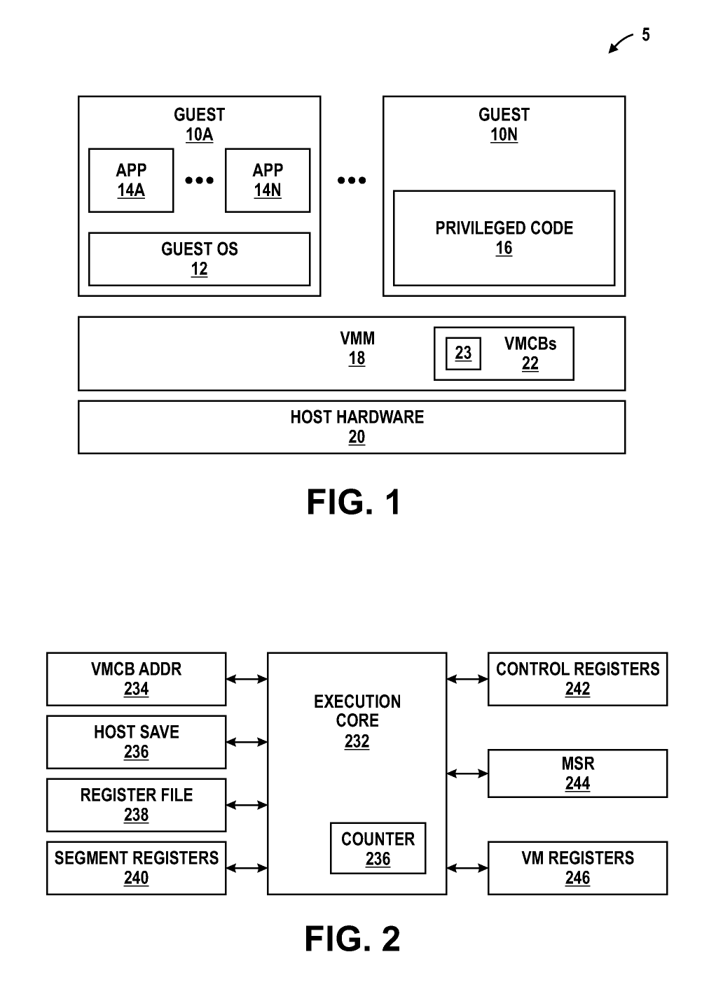

A data processing device is configured such that, during a loop executed by a guest, the device executes a PAUSE instruction. In response to executing a PAUSE instruction, the data processing device determines a relationship between the current PAUSE instruction and a previously executed PAUSE instruction. For example, the data processing device can determine the amount of time that has elapsed between the PAUSE instructions. Based on the relationship between the current and previous pause instructions, the data processing device can reset the counter to a reset value, or adjust (i.e. increment or decrement) the counter by a defined amount. For example, if the data processing device determines the PAUSE instructions were both received during a defined length of time, this indicates that the PAUSE instructions are part of the same loop, referred to as a “spin loop”. Accordingly, the data processing device can adjust a counter that indicates how many times a PAUSE command has been executed since being reset. If the second occurrence of the PAUSE instruction is not received during the defined length of time, thereby indicating the PAUSE instructions are not part of the same spin loop, the data processing device can reset the counter. If the counter reaches a defined threshold, indicating the spin loop has been executed a number of times defined by the threshold, the data processing device executes VMEXIT command to pass control from the VM to the VMM. In this manner, the use of the PAUSE instruction within spin loops can be detected to return control to the VMM, e.g., a world switch, when the loop is executed too many times. Further, PAUSE instructions that are not part of a spin loop, e.g., PAUSE instructions that result from a small short loop, are less likely to execute sufficiently close to each other in time, thereby resulting in the counter being reset, and preventing a world switch based on the PAUSE instruction counter. Specific embodiments of the present disclosure will be better understood with reference to FIGS. 1-4.

Turning now to FIG. 1, a diagram of a device 5 executing a VMM 18 and multiple guests 10A-10n in accordance with one embodiment of the present disclosure is illustrated. In the embodiment of FIG. 1, the device 5 includes host hardware 20 that can execute guest programs including guests 10A and additional guests through guest 10N. Guest 10A includes a guest operating system (OS) 12 and one or more applications 14A-14N. Guest 10N includes privileged code 16. The guests 10A-10N are managed by a virtual machine manager (VMM) 18 that is also executed by the host hardware 20. In one embodiment, the VMM 18 may maintain a set of virtual machine control blocks (VMCBs) 22. There may be one VMCB 22 for each guest 10A-10N. Thus, for example, one VMCB can be associated with guest 10A while a different VMCB is associated with guest 10N. While the VMCBs 22 are shown as part of the VMM 18 for purposes of illustration in FIG. 1, the VMCBs 22 may be stored in memory and/or on non-volatile media such as disk drives in the host hardware 20.

The host hardware 20 generally includes all of the hardware associated with operation of VMM 18, guest 10A and guest 10B, such as an integrated circuit that includes a data processing device. In various embodiments, the host hardware 20 may include a data processing device having one or more processor cores, memory devices, peripheral devices, and other devices used to couple the preceding components. For example, the host hardware 20 can include a Northbridge device that provides an interface between data processing devices, memory, and a graphics device that uses the advanced graphic port (AGP) interface. Additionally, the Northbridge device can provide an interface to a peripheral bus such as the peripheral component interface (PCI) bus. The host hardware 20 can also include a Southbridge device, to provide legacy functionality and/or provide an interface to legacy hardware. In other embodiments, the host hardware 20 can include HyperTransport (HT) links to link nodes, each of which may include one or more processors, a host bridge, and a memory controller. The host bridge may be used to provide an interface, via HT links, between peripheral devices.

In some embodiments, the host hardware 20 may include hardware support to implement virtual machines, e.g., to support virtualization. The VMM 18 is configured to provide the virtualization for each of the guests 10A-10N by controlling the access of the guests 10A-10N to the host hardware 20. The VMM 18 and guests 10A-10N may be configured to use the hardware support provided in the host hardware 20 for virtualization.

The VMM 18 may maintain a set of virtual machine control blocks (VMCBs 22) for each guest 10A-10N that includes information, such as state information, for each VM. For example, in the illustrated embodiment of FIG. 1, the VMM 18 maintains a VMCB 23 for the guest 10A. The VMCB 23 may generally comprise a data structure stored in a storage area that is allocated by the VMM 18 for the corresponding guest 10A. In one embodiment, data associated with the VMCB 23 is stored at a dedicated page of memory, although other embodiments may use larger or smaller memory areas. In one embodiment, the VMCB 23 may include the guest's processor state that is stored to and retrieved from VMCB 23 in response to world switches.

An instruction that transfers control from the VMM to a guest is referred to herein as a “Virtual Machine Run (VMRUN)” instruction. In one embodiment, the VMM 18 may also have a portion of memory (termed, for purposes of discussion, the “VMM state portion”) allocated to store the processor state corresponding to the VMM 18. When the VMRUN is executed, the processor state corresponding to the VMM 18 may be saved in the VMM state portion.

Additionally, the VMCB 23 may include an intercept configuration that identifies intercept events that are enabled for the guest, and the mechanism for exiting the guest if an enabled intercept event is detected. In one embodiment, the intercept configuration may include a set of intercept indications, one indication for each intercept event that the processor supports. The intercept indication may indicate whether or not the processor is to intercept the corresponding event (e.g., whether or not the intercept is enabled). As used herein, an event is “intercepted” in a guest if, should the event occur in the guest, the processor exits the guest for processing of the event. In one embodiment, the intercept configuration may include a second set of indications that indicate which of two exit mechanisms are used. Other embodiments may define more than two exit mechanisms. In another embodiment, the intercept configuration may comprise one set of intercept indications, one per intercept event, that indicate whether or not a first exit mechanism should be used for the event; and a second set of intercept indications, one per intercept event, that indicate whether or not a second exit mechanism should be used for the event.

Generally, the exit mechanism may define the hardware and software operations performed by the processor to exit guest execution (generally in a restartable fashion) and to begin executing other code. In one embodiment, relatively simple intercept processing may be processed through a “lighter weight” exit mechanism which may take less time to perform, which may improve performance in some embodiments. More complicated processing may be performed in the VMM, after a “heavier weight” mechanism is used to exit. Thus, in this embodiment, the VMM 18 may configure the processor to intercept those events that the VMM 18 does not wish the guest 10A-10N to handle internally, and may also configure the processor for which exit mechanism to use. Events may include instructions (that is, intercept an instruction instead of executing it), interrupts, exceptions, and/or any other desired events that may occur during guest execution.

In one embodiment, the VMCB 23 may further include other control bits that may cause the processor to perform certain actions upon loading the VMCB 22. For example, the control bits may include indications to flush the translation look aside buffer (TLB) in the processor. Other control bits may specify the execution environment for the guest (e.g. interrupt handling modes, an address space identifier for the guest, etc.). Still other control bits may be used to communicate an exit code describing why the guest exited, etc.

Generally, a “guest” may comprise any one or more software programs that are to be virtualized for execution in the data processing device. A guest may include at least some code that executes in privileged mode, and thus expects to have full control over the data processing device on which it is executing. Guest 10A is an example in which the guest includes a guest OS. The guest OS may be any OS, such as any of the Windows OS available from Microsoft Corp., (Redmond, Wash.), any UNIX-type operating system such as Linux, AIX from IBM Corporation (Armonk, N.Y.), Solaris from Sun Microsystems, Inc. (Santa Clara, Calif.), HP-UX from Hewlett-Packard Company (Palo Alto, Calif.), etc. The guest 10N is an example of a guest that comprises non-OS privileged code 16.

FIG. 2 is a block diagram illustrating one embodiment of a processor device 200 included in the host hardware 20 of FIG. 1. In the illustrated embodiment, the processor device 200 includes an execution core 232, a VMCB address register 234, a host save register 236, a register file 238, a set of segment registers 240, a set of control registers 242, a set of model specific registers (MSRs) 244, and a set of virtual machine (VM) registers 246. The execution core 232 is connected to each of the registers 234, 236, 238, 240, 242, 244, and 246.

The execution core 232 is configured to execute the instructions defined in the instruction set architecture implemented by the processor device 200 (e.g. the x86 instruction set architecture, including AMD64™ extensions). The execution core 232 may be a superpipelined core, a superscalar core, or a combination thereof in various embodiments. Alternatively, the execution core 232 may be a scalar core, a pipelined core, a non-pipelined core, and the like. The execution core 232 may employ out of order speculative execution or in order execution in various embodiments. The execution core 232 may include microcoding for one or more instructions or other functions, in combination with any of the above constructions.

The register file 238 may comprise various registers, such as control and data registers, defined for use with the instructions that the execution core 232 is configured to execute.

The control registers 242 may comprise a variety of control registers that control the general operating mode of the processor device 200. The control registers, for example, may include various control bits that control protected mode, whether or not paging is enabled, various paging/protected mode options, interrupt enable indications and handling, base addresses of various tables used by the processor such as the segment descriptor tables, the page tables, and the like. The configuration of the control registers 242 can be based on the instruction set architecture of the processor device 200. For example, if the processor device 200 implements the x86 instruction set architecture (including AMD64™ extensions), the control registers 242 may include CR0, CR3, CR4 (not shown) the local descriptor table register (LDTR), the global descriptor table register (GDTR), the interrupt descriptor table register (IDTR), the extended feature enable register (EFER), the debug registers, the task register (TR), the system call registers (STAR, LSTAR, CSTAR, SFMASK, etc.), and the like.

The MSRs 244 may comprise one or more registers that are implementation dependent. That is, the instruction set architecture may permit a given implementation to define any set of MSRs 244 that may be desirable for that implementation.

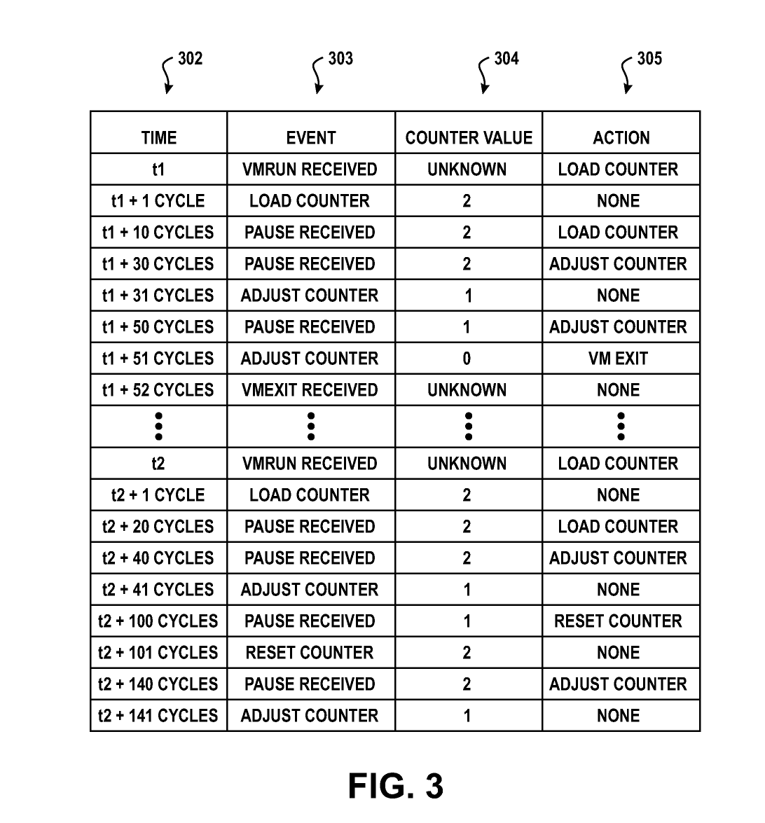

The VM registers 246 comprise one or more registers that are included in the processor device 200 to provide virtual machine support (that is, to support virtualization for the guests 10A-10N of FIG. 1). The VMCB address register 234 and the host save register 236 may be considered to be VM registers 246, but have been shown separately in FIG. 3 for purposes of illustration. For example, the VM registers 246 may include registers that may be loaded with virtual interrupt state to permit an interrupt to be injected into a guest.

The segment registers 240 may be provided in accordance with the x86 instruction set architecture. More particularly, the segment registers 240 may be part of the privilege protection mechanism employed by the processor device 200 when the processor is in protected mode. In protected mode, each segment register 40 may be loaded with a segment selector using a segment load instruction. The segment selector identifies a segment descriptor in a segment descriptor table in memory that sets the privilege level for the segment and also includes other protection control bits and other information. When a segment selector is loaded into a segment register, the execution core 232 loads the segment descriptor from the segment descriptor table and loads the descriptor information, or information derived from the segment descriptor, into a hidden portion of the segment register.

The execution core 235 includes a counter 236. In response to determining a VMRUN instruction occurred, the execution core 235 loads the counter 236 with a value, referred to for purposes of discussion as a “reset value.” During execution of a guest, the execution core can execute a PAUSE instruction (referred to for purposes of discussion as “PAUSE2”), indicating the guest is in a spin loop. During execution of the PAUSE1 instruction, the execution core 235 determines whether a previous PAUSE instruction (referred to for purposes of discussion as “PAUSE1”, where PAUSE1 and PAUSE2 represent different instances of the same type of PAUSE instruction) has been executed at the execution core after the VMRUN instruction. If not, the execution core 235 does not adjust the value stored at the counter 236.

If PAUSE1 was executed, the execution core 235 determines whether the PAUSE1 and PAUSE2 instructions have a defined relationship. For example, the execution core 235 can determine whether the PAUSE1 and PAUSE2 instructions occur within a defined period of time, whether they are associated with the same instruction pointer, whether they are part of the same program loop, and the like, or a combination thereof. The defined relationship indicates that the PAUSE1 and PAUSE2 instructions are part of the same spin loop. Accordingly, if the execution core 235 determines that PAUSE1 and PAUSE2 have the defined relationship, it adjusts the value stored at the counter 236, for example, the counter can be adjusted. As used herein, adjusting the counter refers to incrementing or decrementing the value stored at the counter by a designated amount. In response to adjusting the value stored at the counter 236, the execution core 235 determines whether the counter value matches a threshold. If so, the execution of the pause instruction causes the execution core 235 to execute VMEXIT event, e.g., a VMEXIT instruction, resulting in a world switch from the VM to the VMM 18.

If the PAUSE1 and PAUSE2 instructions do not have the defined relationship, this indicates that they are not likely to be part of the same spin loop. Accordingly, the execution core 235 resets the value stored at the counter 236 to the reset value. Thus, because the value stored at the counter 236 is adjusted only when PAUSE instructions are likely to be part of the same spin loop, and is reset when PAUSE instructions are likely part of different spin loops, a world switch from guest to the VMM 18 is only likely to occur in response to a relatively long spin loop. That is, relatively short spin loops are unlikely to cause a world switch, improving the efficiency of the data processing device 5.

In a particular embodiment, comparison of the PAUSE instructions and adjustment or resetting of the value stored at the counter 236 is performed automatically by the execution core 235 during execution of each PAUSE instruction. Thus, for example, adjustment or resetting of the counter can be executed by microcode associated with the PAUSE instruction. Accordingly, the value stored at the counter 236 does not have to be managed via a higher level program of instructions, improving the efficiency of the higher level program.

The operation of the execution core 235 in response to a PAUSE instruction can be better understood with reference to FIG. 3, which illustrates an exemplary operation of the core. In particular, column 302 of FIG. 3 indicates a particular time. Each time is designated by a base time and an offset number of cycles from that time. For example, the time “t₁+20 cycles” refers to a point in time 20 cycles after time t₁. The cycles can be cycles of a periodic clock signal, such as a clock signal used to synchronize operations of the execution core 235, or can simply be an indicator of the relative amount of time elapsed since the associated base time.

Column 303 indicates an event at the execution core 235 that occurs at the associated time indicated in column 302. Column 304 indicates the value stored at counter 236 at the time indicated by the column 302. Column 305 indicates an action to be taken by the execution core 235 in response to the event at column 303.

In the illustrated example of FIG. 3, at time t₁ the execution core 235 receives a VMRUN instruction to execute a guest. In response, at time t₁+1 cycle, the execution core 235 loads the counter 236 with the reset value. For purposes of the example of FIG. 3, it is assumed the reset value is “2.” Further, it is assumed for the purposes of the example that the value at counter 236 that will cause a VMEXIT event is the value “0.” In addition, it assumed that the value at counter 236 will be adjusted if PAUSE instructions are executed at the execution core 235 within 50 cycles of each other, and the value will be reset if PAUSE instructions are executed at the execution core 235 with a separation of greater than 50 cycles.

At time t₁+10 cycles, the execution core 235 receives a PAUSE instruction. For purposes of discussion, it is assumed that any previously received PAUSE instruction was received more than 50 cycles previous. Accordingly, the execution core 235 loads the reset value to the counter 236. At time t₁+30 cycles, the execution core 236 receives a PAUSE instruction. During execution of the PAUSE instruction, the execution core 235 determines that the previous PAUSE instruction was executed 20 cycles ago. Accordingly, at time t₁+31 cycles, the execution core 235 adjusts the value stored at the counter 236 to the value “1.”

At time t₁+50 cycles, the execution core 236 receives a PAUSE instruction. During execution of the PAUSE instruction, the execution core 235 determines that the previous PAUSE instruction was executed 20 cycles ago, at time t₁+30 cycles. Accordingly, at time t₁+51 cycles, the execution core 235 adjusts the value stored at the counter 236 to the value “0.” In response to the value stored at counter 236 reaching 0, the execution core 235 causes a VMEXIT event at time t₁+52 cycles, resulting in execution of the VMM 18.

At time t₂, the execution core 235 receives a VMRUN instruction to execute a guest. In response, at time t₂+1 cycle, the execution core 235 loads the counter 236 with the reset value. At time t₂+20 cycles, the execution core 235 receives a PAUSE instruction. The execution core 235 determines the previous PAUSE instruction was received more than 50 cycles previous and therefore loads the reset value to counter 236. At time t₂+40 cycles, the execution core 236 receives a PAUSE instruction. During execution of the PAUSE instruction, the execution core 235 determines that the previous PAUSE instruction was executed 20 cycles ago, at time t₂+20 cycles. Accordingly, at time t₁+41 cycles, the execution core 235 adjusts the value stored at the counter 236 to the value “1.”

At time t₁+100 cycles, the execution core 236 receives a PAUSE instruction. During execution of the PAUSE instruction, the execution core 235 determines that the previous PAUSE instruction was executed 60 cycles ago, at time t₁+40 cycles. Accordingly, at time t₁+101 cycles, the execution core 235 resets the value stored at the counter 236 to the reset value “2.” Thus, because the PAUSE instructions did not occur within the threshold time of 50 cycles, indicating the instructions are not part of the same spin loop, the value at the counter 236 is reset.

At time t₂+140 cycles, the execution core 236 receives a PAUSE instruction. During execution of the PAUSE instruction, the execution core 235 determines that the previous PAUSE instruction was executed 40 cycles ago, at time t₂+100 cycles. Accordingly, at time t₁+141 cycles, the execution core 235 adjusts the value stored at the counter 236 to the value “1.” Thus, PAUSE instructions which are likely part of the same spin loop result in adjustment of the stored value at the counter 236. Only PAUSE instructions which are likely part of the same spin loop are therefore likely to result in a VMEXIT event, improving the efficiency of the data processor device 5.

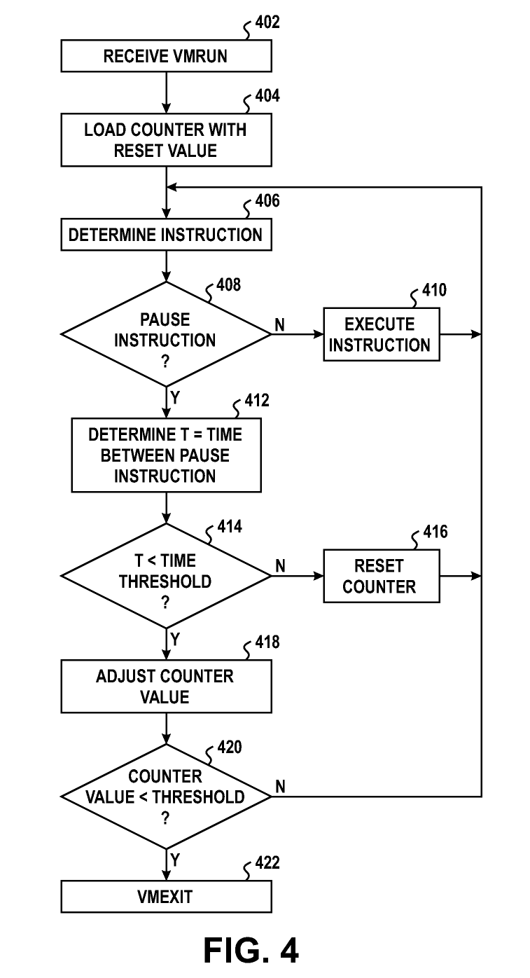

FIG. 4 illustrates a flow diagram of a method of switching from a guest to a VMM in accordance with one embodiment of the present disclosure. At block 402, the execution core 235 receives a VMRUN instruction. In response, at block 404 the execution core 235 loads the counter 236 with a reset value. In an embodiment, the reset value is a programmable value that can be set by the VMM 18 or by the guest being executed. At block 406, the execution core 235 determines the next instruction to be executed. At block 408, the execution core determines whether the next instruction is a PAUSE instruction. If not, the method flow proceeds to block 410 and the next instruction is executed.

If the next instruction is a PAUSE instruction, the method flow moves to block 412 and the execution core 235 determines a time value T, where T is the time between the PAUSE instruction being executed and the previous PAUSE instruction. At block 414, during execution of the PAUSE instruction the execution core 235 determines whether the time T is less than a threshold value. In an embodiment, the threshold value is a programmable value that can be set by the guest being executed, by the VMM 18, and the like.

If the time T is not less than the threshold value, this indicates the PAUSE instructions are part of different spin loops. Accordingly, the method flow moves to block 416 and the value stored at the counter 236 is set to the reset value. The method flow returns to block 406 to determine the next instruction. If the time T is less than the threshold value, this indicates the PAUSE instructions are part of the same spin loop. Accordingly, the method flow proceeds to block 418 and the execution core 235 adjusts the value stored at the counter 236. At block 420 the execution cores 235 determines if the value stored at the counter 236 is less than a threshold value. If not, the method flow moves to block 406 and the execution core 235 determines the next instruction to be executed. If the value stored at the counter 236 is less than the threshold value, this indicates the executing guest has been in a spin loop for more than a defined period of time. Accordingly, the method flow moves to block 422, and the execution core 235 causes a VMEXIT event, resulting in execution of the VMM 18.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. For example, it is noted that the letter “N” when used herein in reference numerals such as 10N is meant to generically indicate any number of elements bearing that reference numeral (e.g. any number of guests 10A-10N, including one guest). Additionally, different reference numerals that use the letter “N” (e.g. 10N and 14N) do not necessarily indicate like numbers of the different elements are provided (e.g. the number of guests 10A-10N may differ from the number of applications 14A-14N). Further, the term register refers to any storage location implemented in the processor that is addressable (or otherwise accessible) using an instruction. Registers may be implemented in various fashions. For example, registers may be implemented as any sort of clocked storage devices such as flops, latches, etc. Registers may also be implemented as memory arrays, where a register address may be used to select an entry in the array. The register file 238 may be implemented in such a fashion, in some embodiments. Any combination of implementations may be used in various embodiments of the processor device 200. The various registers 234, 236, 238, 240, 242, 244, and 246 may comprise processor state in one embodiment. Any other registers may be implemented in other embodiments that may be part of the processor state.

What is claimed is:

1. A method, comprising:
determining a first occurrence of a first operation at a first virtual machine;
determining a second occurrence of the first operation at the first virtual machine;
determining a relationship between the first occurrence and the second occurrence;
adjusting a value stored at a counter in response to determining the relationship is a first relationship;
resetting the counter to a reset value in response to determining the relationship is a second relationship; and
exiting the first virtual machine in response to the value stored at the counter matching a first threshold, executing a virtual machine manager at the data processing device.

2. The method of claim 1, wherein the second occurrence comprises a first instruction, and wherein determining the relationship comprises determining the relationship during execution of the first instruction.

3. The method of claim 1, wherein the first relationship comprises the first occurrence and the second occurrence occurring within a first period of time.

4. The method of claim 3, wherein the second relationship comprises the first occurrence and the second occurrence not occurring within the first period of time.

5. The method of claim 3, wherein the first period of time is programmable.

6. The method of claim 1, wherein the first relationship comprises the first occurrence and the second occurrence being associated with a common instruction pointer.

7. The method of claim 6, wherein the second relationship comprises the first occurrence and the second occurrence being associated with different instruction pointers.

8. The method of claim 1, wherein the first relationship comprises the first occurrence and the second occurrence being associated with a common instruction loop.

9. The method of claim 1, wherein adjusting the value stored at the counter comprises adjusting the value stored at the counter in response to determining a third relationship between the first occurrence of the first operation and the second occurrence.

10. The method of claim 9, wherein the first relationship comprises the occurrence of the first operation and the occurrence of the second operation occurring within a first period of time and the third relationship comprises the first operation and the second operation being associated with a common instruction pointer.

11. The method of claim 1, further comprising:
determining a third occurrence of the first operation at a second virtual machine;
determining a fourth occurrence of the first operation at the second virtual machine;
determining a relationship between the third occurrence and the second occurrence;
adjusting a value stored at a counter in response to determining the relationship is a third relationship;
resetting the counter to a reset value in response to determining the relationship is a fourth relationship; and
exiting the second virtual machine in response to the value stored at the counter matching a first threshold, executing a virtual machine manager at the data processing device.

12. The method of claim 11, wherein the first relationship comprises the first occurrence and the second occurrence occurring within a first period of time and the third relationship comprises the third occurrence and the fourth occurrence occurring within a second period of time different than the first period of time.

13. The method of claim 11, wherein the first relationship comprises the first occurrence and the second occurrence occurring within a second period of time and the second relationship comprises the third occurrence and the fourth occurrence being associated with a common instruction pointer.

14. The method of claim 1, further comprising:
while executing the virtual machine manager, determining a third operation at the data processing device associated with the first virtual machine;
in response to determining the third operation, setting the counter to the reset value.

15. A device, comprising:
a counter;
an execution core coupled to the counter, the execution core configured to:
determine a first occurrence of a first operation at a first virtual machine;
determine a second occurrence of the first operation at the first virtual machine;
determine a relationship between the first occurrence and the second occurrence;
adjust a value stored at a counter in response to determining the relationship is a first relationship;
reset the counter to a reset value in response to determining the relationship is a second relationship; and
exit the first virtual machine in response to the value stored at the counter matching a first threshold, executing a virtual machine manager at the data processing device.

16. The method of claim 15, wherein the second occurrence comprises a first instruction, and wherein the execution core is configured to determine the relationship between the first occurrence and the second occurrence during execution of the first instruction.

17. The device of claim 15, wherein the first relationship comprises the first occurrence and the second occurrence occurring within a first period of time.

18. The device of claim 17, wherein the first period of time is programmable.

19. The device of claim 15, wherein the first relationship comprises the first occurrence and the second occurrence being associated with a common instruction pointer.

20. The device of claim 15, wherein the first relationship comprises the first occurrence and the second occurrence being associated with a common instruction loop.
